(19) United States
(12) Patent Application Publication
(10) Pub. No.: US 2026/0140635 A1
(43) Pub. Date: May 21, 2026

(54) NON-VOLATILE MEMORY DEVICE AND METHOD FOR SIMULTANEOUSLY READING TWO MEMORY BANKS

(71) Applicant: STMicroelectronics International N.V., Geneva (CH)

(72) Inventor: Olivier PLOURDE, Aix en Provence (FR)

(73) Assignee: STMicroelectronics International N.V., Geneva (CH)

(21) Appl. No.: 19/388,072

(22) Filed: Nov. 13, 2025

(30) Foreign Application Priority Data
Nov. 15, 2024 (FR) 2412487

(51) Int. Cl. G06F 3/06

(52) U.S. Cl. CPC G06F 3/0613; G06F 3/0619; G06F 3/0659; G06F 3/0679

(57) ABSTRACT

A memory device includes a memory interface that receives instructions from a host device. A non-volatile memory (NVM) controller is connected to at least two memory banks storing data. The NVM controller receives a first command to read a data unit, where the command indicates a first read memory address, and in response to the command: simultaneously reads a data unit at a bank memory address in a first bank corresponding to the first read memory address and a data unit at the same bank memory address in the second bank, and then transmits the read data unit to the memory interface and store the data unit in a data register.

### PRIORITY CLAIM

This application claims the priority benefit of French Application for Patent No. FR2412487, filed on Nov. 15, 2024, the content of which is hereby incorporated by reference in its entirety to the maximum extent allowable by law.

### TECHNICAL FIELD

Embodiments and implementations relate to the field of computers and, more particularly, to non-volatile storage devices in the field of computing and methods of accessing non-volatile memory devices. More particularly, they relate to a memory device and a memory management method for a non-volatile memory (NVM) module, an NVM controller and a memory storage device using the method, which are capable of increasing the speed of reading and writing data to thereby improve the efficiency of the non-volatile memory.

### BACKGROUND

A conventional non-volatile memory (NVM) bank made up of an array of memory cells controlled by an NVM controller can be read or written using a read or write command. However, the memory is no longer accessible during the read or write operation. This latency can last a plurality of memory clock cycles (or “wait states”).

In some cases, there may be special needs for accelerated access to memory banks for reading and writing data. Memory banks of the prior art with an access bus having a width of 128 bits often have significant latency problems when reading or writing data to the memory banks.

In order to increase the number of data read and written at the same time, one of the solutions of the prior art consists in introducing memories with doubled access buses, for example having a width of 256 bits. However, this solution has a plurality of disadvantages such as increased power consumption, increased and densified access bus lines for writing and reading data, and increased memory bank size.

Furthermore, the 256-bit wide bus requires a more complex and more difficult to implement error correction code (ECC) which results in a more complex memory. The error correction code on larger data also increases the latency of its decoding and therefore that of the reading of the data.

Another solution consists in using two parallel non-volatile memories to simultaneously read two data words. However, in addition to increased power consumption, the “read while write” functionality of the two memories is no longer ensured, since they are used simultaneously.

### SUMMARY

Embodiments herein propose overcoming the drawbacks of the prior art by providing a non-volatile memory device capable of meeting the specific needs of fast data transmission while remaining simple, inexpensive and easy to program.

According to one aspect, a memory device comprises a memory interface configured to receive instructions from a host device. The memory device further comprises an NVM controller connected to at least two non-volatile memory banks storing data. The NVM controller is configured to receive from the memory interface a first command to read a data unit, the first command indicating a first memory address, and in response to the first command: Simultaneously read a first data unit at a bank memory address in a first one of the non-volatile memory banks that corresponds to the first memory address and a second data unit at the same bank memory address in the second non-volatile memory bank, and then transmit the read first data unit to the memory interface and store the second data unit in a data register of the NVM controller.

Thus, accelerated access to memory banks for reading data is provided.

Preferably, the NVM controller is configured to receive, from the memory interface, a second command to read a data unit and in response to the second command: Read the second data unit from the data register and transmit the read second data unit to the memory interface.

This makes it possible to speed up the reading of the second data unit directly from the data register without consulting the memory bank. Reading data directly from the data register makes it possible to reduce the latency of a plurality of memory clock cycles.

In one embodiment, the NVM controller is configured to send the second data unit from the data register to the memory interface after a clock cycle following receipt of the second read command.

In this embodiment, the latency is reduced to one clock cycle. The standby clock cycle particularly makes it possible to ensure that all read operations in the register are complete, and therefore prevents any read errors.

In a particular embodiment, the memory interface is configured to determine whether a new command to be sent to the NVM controller is of a first type ‘type 1’ or of a second type ‘type 2’, the new command to be sent being of ‘type 2’ if the second data unit to be read is stored at the same bank memory address in the second memory bank, as the first data unit read by the first command sent to the NVM controller, otherwise the new command to be sent is of ‘type 1’.

The new command is preferably consecutive to the first command.

Advantageously, the NVM controller receiving the new command being of ‘type 1’ is configured to read the second data unit in the second memory bank, the NVM controller receiving the new command being of ‘type 2’ is configured to read the second data unit in the data register.

By determining through the memory interface, when receiving instructions from a host device, the type of new command to send to the NVM controller, it is possible to reduce the latency of a plurality of memory clock cycles. The NVM controller, in the case of the new ‘type 2’ command, reads the second requested data unit directly in the data register. The second data unit being previously stored in the data register. The NVM controller therefore does not need to consult the second memory bank to access the second data unit but directly in the data register, thus making it possible to avoid the waiting time for processing access to the data units.

This is particularly advantageous in the embodiment with the new type 2 command, since it is not necessary to access the memory banks at each read cycle.

In the case of the second command type 1, the second data unit is not stored at the same memory address as the first data unit and the controller continues the “conventional” reading of data in the second memory bank.

In another particular embodiment, the NVM controller is configured to send the second data unit from the data register to the memory interface in the clock cycle following receipt of the second read command.

In this particular embodiment, the sending of the second data unit from the data register takes place without any waiting clock cycle making it possible to speed up the data transmission.

This means that the second data unit can be transmitted in the clock cycle following the transmission of the first data unit, if the memory interface is sequencing the read commands. Therefore, no latency between the transmission of the data units is observed in this embodiment.

Preferably, the first read memory address comprises one or more bank control bits and distinct bits defining the bank memory address. This addressing format simplifies controller operations, since simultaneous read operations of both banks are performed using these separate bits only. The control bit(s) make(s) it possible for the controller to determine which data unit read in this way is to be returned.

It should be noted that the comparison of the read addresses between two successive commands is simplified, in order to decide whether the second data unit stored in the register is to be sent.

The control bit(s) may be of high order, whereas the distinct bits are the low order bits.

In one example, the data unit comprises a data word and an error correcting code (ECC), wherein the data word is a binary word of 16, 32, 64, 128, 256, 512 or 1024 bits.

In one embodiment, the device comprises a mode bit configurable to take either a first value M1 or a second value M2, the memory device and being configured to: when the mode bit takes the first value M1, control the NVM controller so that in response to a read command, it reads only one of the non-volatile memory banks and transmits to the memory interface a read data unit; and when the mode bit takes the second value M2, control the NVM controller so that in response to a read command, either it simultaneously reads the first and second non-volatile memory banks, at the bank memory address, transmits a read data word to the memory interface and stores the other read data word in the data register, or it reads only one data word directly in the data register.

The mode bit can be recorded, in a register or a part of the memory, either within the NVM controller or within the memory interface and is programmable by the user. The user can therefore choose the operation of the NVM controller via the mode bit. Accelerated reading of data can be requested by the user in cases where necessary. In addition, the memory device can retain a conventional operation.

Advantageously, the memory interface is configured to receive a data write instruction, convert said write instruction into two data write commands and transmit said commands to the NVM controller to write the data into two data units stored at the same bank address in both memory banks.

Similar to how the memory interface works when reading data, the memory interface converts the write instruction into two data write commands. The NVM controller is therefore configured to write data to both data units at the same bank address in both banks of memory. This is particularly advantageous for reading data afterwards because the reading of data is not necessarily sequential after each memory bank but can be simultaneous, which makes it possible to speed up the reading of data.

Preferably, the memory device comprises a bank bus being configured to simultaneously read the first data unit at a memory address of the first non-volatile memory bank corresponding to the first memory address and the second data unit at the same memory address of the second non-volatile memory bank, and to transmit said data units to the NVM controller.

The bank bus is specially programmed for simultaneous reading of the data units in the same memory address in both memory banks.

According to another aspect, a method for reading data units in a memory device comprises the steps of: receiving via a memory interface read commands from a host device; transmitting via the memory interface to an NVM controller a first read command of a data unit, the first read command indicating a first read memory address; in response to the first read command, simultaneously reading by the NVM controller a first data unit at a memory address of a first bank of non-volatile memory corresponding to the first read memory address and reading a second data unit at the same memory address of a second bank of non-volatile memory; and transmitting by the NVM controller the read first data unit to the memory interface and storing the second data unit in a data register of the NVM controller.

### BRIEF DESCRIPTION OF THE DRAWINGS

Other advantages and features of the invention will become apparent upon examining the detailed description of non-limiting embodiments and implementations, and from the appended drawings wherein:

FIG. 1 schematically represents in the form of blocks a system interfacing a host device with a non-volatile NVM memory device;

FIG. 2 is a flow chart illustrating steps of a memory device reading process;

FIG. 3 is a diagram illustrating an example of read operation signals at the memory interface; and

FIG. 4A and FIG. 4B illustrate performance of the foregoing method, in two scenarios, for responding to a batch read instruction.

### DETAILED DESCRIPTION

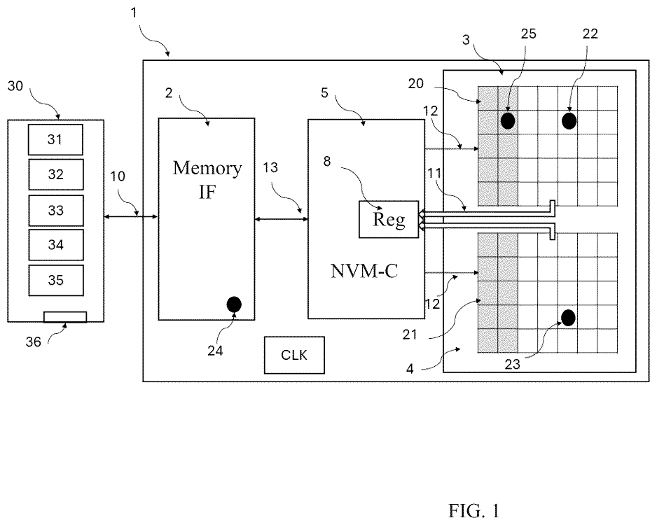

FIG. 1 schematically represents in the form of blocks a system interfacing a host device 30 with a non-volatile memory (NVM) device or module 1 (NVM device) storing data words of size N.

The host device 30 comprises a microcontroller or CPU 31 communicating with the NVM device 1, for example, to execute computer program code instructions stored in the NVM device 1.

The microcontroller 31 executes computer programs stored on the NVM device 1 as is well known to those skilled in the art. For example, in conventional computing devices, an execution operating system can send a data read request to the microcontroller 31 as well as logical addresses to access a data unit (or data page) stored in the NVM device 1.

The host device 30 includes one or more volatile memories, also called user memory 32. The user memory 32, for example a random access memory (RAM), makes it possible to store dynamic variables linked to the execution of the program by the microcontroller 31.

The host device 30 also comprises a memory management unit (MMU) 33 coupled to a memory controller 34, as well as one or more cache memories 35. The host device 30 can be connected to an external memory and other peripheral devices via an input/output (I/O) interface 36 for communication with the outside of the host device 30.

The memory management unit (MMU) 33 translates the logical memory addresses of a client (such as an operating system executed by the microcontroller 31) into physical memory addresses that may correspond to physical locations on the NVM device 1.

The memory controller 34 communicates via a data path 10 (typically a communication bus) with a memory interface 2 of the NVM device 1. The communication can be carried out in accordance with a master-slave protocol such as the Advanced eXtensible Interface (AXI) protocol (for example the AMBA AXI Protocol version 2.0 specification), in order to write or read data in the NVM memory 1. The bus 10 has an N/2 dimension, for example 64 bits for data words of 128 bits in the NVM device 1.

The NVM device 1 can be implemented on a single chip or be multichip, or on a plurality of discrete components.

The NVM device 1 comprises, in addition to the memory interface (IF) 2, one or more memories (here only one) each formed by an NVM controller 5 and two banks of non-volatile memory 3, 4. The NVM controller 5 communicates with the memory interface 2 via an internal bus 13 of dimension N. In addition, the memory interface 2 is configured to convert words of dimension N on the internal bus 13 into words of dimension N/2 on the external bus 10, and vice versa.

The NVM memory banks 3, 4 are preferably of the same size. They can be of the NAND, NOR and/or AND types.

Each NVM memory bank 3, 4 is formed by a matrix of cells organized in rows and columns, controlled by the NVM controller (NVM-C) 5 via address buses 12 and row and column decoding circuits (not shown). Each NVM memory bank 3, 4 also comprises amplifiers (not shown) at the head of the column coupled to a bidirectional data bus 11 for reading data units by the NVM controller 5. Other known components, inherent in the use of memory, are not illustrated or described further for reasons of concision. By way of example, a control bus (not shown) makes it possible to control the memory bank in read or write mode.

These memory banks 3, 4 remain conventional. In addition, the teachings of the present disclosure can advantageously reuse existing hardware memory architectures.

The NVM memory banks 3, 4 are organized to store data words of size N, for example 16, 32, 64, 128, 256, 512 or 1024 bits, with optionally error correction code (ECC) bits, for example 8 bits forming a total of 136 memory cells per 128-bit memory word.

In the remainder of the description, reference will be made mainly to 128-bit words for reasons of practicality.

The address bus 12 is configured to address these data words, while the data bus 11 is dimensioned to transmit these data words.

The NVM memory banks 3, 4 have the same physical addressing of the data words. These addresses are referred to hereinafter as the “bank address”. Any bank address in the first NVM memory bank 3 also exists in the second NVM memory bank 4. Thus, for any first data word 20 in the NVM memory bank 3, there is a second data word 21 at the same bank address in the NVM memory bank 4.

The memory interface 2 is configured to receive instructions from the host device 30, either write or read instructions. In particular, the memory interface 2 can receive a batch read instruction, known as a “wrap burst”. By way of example, the host device 30 can request, at once, the transfer of four words of 64 bits to obtain 256 bits at once. The memory interface 2 converts this instruction into read commands READ 1, READ 2 to the NVM controller 5 via the internal bus 13.

Symmetrically, the memory interface 2 can convert write instructions to WRITE 1, WRITE 2 commands to the NVM controller 5.

Thus, the NVM controller 5 is connected to at least two non-volatile memory banks 3, 4 and is configured to receive, from the memory interface 2, one or more read commands READ 1, READ 2 or write commands WRITE 1, WRITE 2 from one or more data units 20, 21.

The read address specified in the read instruction of the host device 30 may be a physical memory address from the MMU 33 or a logical address, in which case the memory interface 2 may comprise a logical address-to-physical address conversion layer.

The read or write commands sent by the memory interface 2 thus comprise a physical address for reading/writing a 128-bit data word (more generally of length N). This address can consist of one or more bank control bits and separate bits defining a bank (physical) memory address. The control bit or bits are, in particular, the most significant bits (MSB) of the read address, typically the MSB bit whose value indicates whether the data word to be read/written is in the first NVM memory bank 3 or in the second NVM memory bank 4. The distinct bits are formed of the least significant bits (LSB) and indicate the physical address within the NVM memory bank targeted by the MSB.

For example, the address “01110101” (one byte for simplicity) designates the bank address “x1110101” in the first NVM bank 3 (where the most significant bit (MSB)=0), while the address “11110101” designates the same bank address “x1110101” in the second NVM bank 4 (MSB=1).

The NVM controller 5 is configured to perform simultaneous (i.e., parallel) reading of the two NVM memory banks 3, 4 during a read operation, and to return only one of the read data words to keep the other in a local data register (Reg) 8 (a memory location internal to the NVM controller) for subsequent fast access. Simultaneous reading is performed by simultaneously indicating the same bank memory address on the two address buses 12, and by simultaneously reading the data buses 11 of the two banks 3, 4.

The data register 8 has an intermediate storage which records the second data unit 21 until the next read command, for example, READ 2.

Thus, this new mode of operation of the NVM device 1 can be defined as a 2N-bit read mode, for example a 256-bit mode for 128-bit data words in memory.

In one embodiment, the register 8 has a size of 2N to store the two words read. The data buses 11 can thus supply the register 8 directly. In a variant, the register 8 is of size N to store the word not returned in response to the read command. The NVM controller 5 then comprises a switching element for switching the data bus 11 of the word to be stored to the register 8.

The NVM controller 5 is configured, in response to a first read command READ 1, to simultaneously read in the first NVM memory bank 3 a first data word 20 at the bank memory address corresponding to the read address of the command and a second data word 21 stored at the same bank memory address in the second NVM memory bank 4. The NVM controller 5 can then transmit the first data word 20 read to the memory interface 2 which then transmits this data to the host device 30, for example in the form of words of size N/2 in response to the instruction received from the host device 30.

The second read data word is therefore readily available when a next read command wishes to access this word. In particular, when the NVM controller 5 receives, from the memory interface 2, a second command READ 2 for reading the data word corresponding to said bank memory address already read, then, in response to the second command READ 2, it reads the second data word 21 from the data register 8, and not by accessing the second NVM memory bank 4, then transmits the second read data word 21 to the memory interface 2.

In one embodiment, the first read command READ 1 indicates a first read memory address 22 and the second read command READ 2 indicates a second read memory address 23. The first read memory address 22 and the second read memory address 23 may differ only by their control bit(s), namely the MSB in the above example. Thus, the physical bank address (formed of the least significant bit (LSB) bits) is the same. This bank physical address identity between the two consecutive commands makes it possible for the NVM controller 5 to identify that it is appropriate to read the register 8 only, in order to process the second read command received.

In another embodiment, the commands READ 1 and READ 2 may be of different types: one type, referred to herein as ‘type 1’, indicating that it is appropriate (for the NVM controller 5) to read the two NVM memory banks 3, 4 at the physical bank address indicated by the LSB bits, and the other type, referred to as ‘type 2’, indicating that it is appropriate to read only, in the register 8, the word read not yet returned. In this embodiment, it is the memory interface 2 which determines the link between two successive commands. In particular, the memory interface 2 determines, from the instructions received from the host device 30, whether a new command to be sent to the NVM controller 5 is of a first type ‘type 1’ or is of a second type ‘type 2’ in the case where the data word 21 to be read in response to this new command is stored at the same bank memory address 25 as a data word 20 already read by the preceding command READ 1, but in the second memory bank 4. Otherwise, the new command to send is of ‘type 1’.

When the read command READ 1 is received, the NVM controller 5 indicates, on the address buses 12, the bank address 25 corresponding to the read address of the command (keeping the LSB bits for example) and activates the read operations. In response, the NVM controller 5 can read, after a few clock cycles, on the two data buses 11 to supply the register 8, then send the corresponding data word back to the NVM memory bank targeted by the command READ 1.

When the read command READ 2 is received with the same bank address 25, the NVM controller 5 reads only the register 8 to return to the memory interface 2 the data word corresponding to the other NVM memory bank targeted by this command READ 2.

In order to be able to efficiently use the data words read simultaneously in the two memory banks 3, 4, special programming can be provided in the NVM controller 5 during write operations. Indeed, it is preferable to store two data words linked to the same bank addresses 25 in the two NVM memory banks 3, 4. In particular, the memory interface 2 is configured to receive a data write instruction, for example a batch write instruction (WRAP burst) of four data units of size N/2 (i.e., 2N bits in total), convert said write instruction into two data write commands WRITE 1, WRITE 2, and transmit these commands to the NVM controller 5 to write the data in two data words 20, 21 stored at the same bank address 25 in the two memory banks 3, 4.

During write operations, the NVM controller 5 indicates the desired bank address 25 on the two address buses 12, and the two N-bit words on the two data buses 11. The two data words 20, 21 are thus recorded at the same bank address 25. When reading two data units 20, 21, the NVM controller 5 can read data recorded at the same bank address 25 on the two memory banks 3, 4.

As illustrated in FIG. 1, the NVM device 1 also includes a conventional clock CLK source which emits a clock signal FCLK which clocks the communications on the buses 10, 11, 12, 13, as will be further understood below from reference to FIG. 3.

The 2N-bit read mode (simultaneous reading of the two NVM memory banks 3, 4) can be permanent, the memory interface 2 generating read commands of the ‘type 1’ or ‘type 2’ type or the NVM controller 5 identifying when a successive command requests the data word stored at the same bank address as the last word read, but in the other NVM memory bank.

In one embodiment, the 2N-bit mode can be activated upon request by an operator in order to maintain a conventional operation or N-bit read mode (read from the targeted NVM memory bank only). This activation of the N-bit or 2N-bit modes can be controlled by the value of a mode bit 24 stored in the NVM device 1, for example in the memory interface 2 (as shown in FIG. 1 by way of illustration), in the NVM controller 5 or in a reserved area of the NVM memory banks 3, 4.

The value of the mode bit 24 thus determines the behavior of the memory interface 2 (to send type 1 or type 2 commands, or other commands) or NVM controller 5 (to determine whether a subsequent command requests the data word stored at the same bank address as the last word read, but in the other bank of NVM memory).

For example, in the first case, the NVM device 1 comprises a mode bit 24 taking either a first value M1 for the N-bit mode (for example bit=0), or a second value M2 for the 2N-bit mode (for example bit=1). The memory interface 2 is configured, when the mode bit 24 takes the first value M1, to control the NVM controller 5 so that in response to a read command READ 1, READ 2, the NVM controller 5 reads only one of the non-volatile memory banks 3, 4 and transmits to the memory interface 2 a read data unit 20, 21. Thus, the NVM controller 5 operates in the so-called “conventional” embodiment without accelerated access to the data banks. This mode bit can be programmed and is active when required by the user. For example, the memory interface 2 can send commands of the type ‘type 0’, identified by the NVM controller 5 as indicating a classic read.

When the mode bit 24 takes the second value M2 (2N bit mode), the memory interface 2 is configured to control the NVM controller 5 so that in response to a read command READ 1, READ 2, either the NVM controller 5 simultaneously reads the first and second non-volatile memory banks 3, 4, at the bank memory address 25, transmits a read data word 20 to the memory interface 2 and stores the other read data word 21 in the data register 8, or it reads only one data word 21 directly in the data register 8. With this M2 value, the user can enable accelerated reading of data words using the data register 8. For example, the memory interface 2 can send commands of type ‘type 1’ or ‘type 2’, identified by the NVM controller 5 as indicating one or the other of the operations.

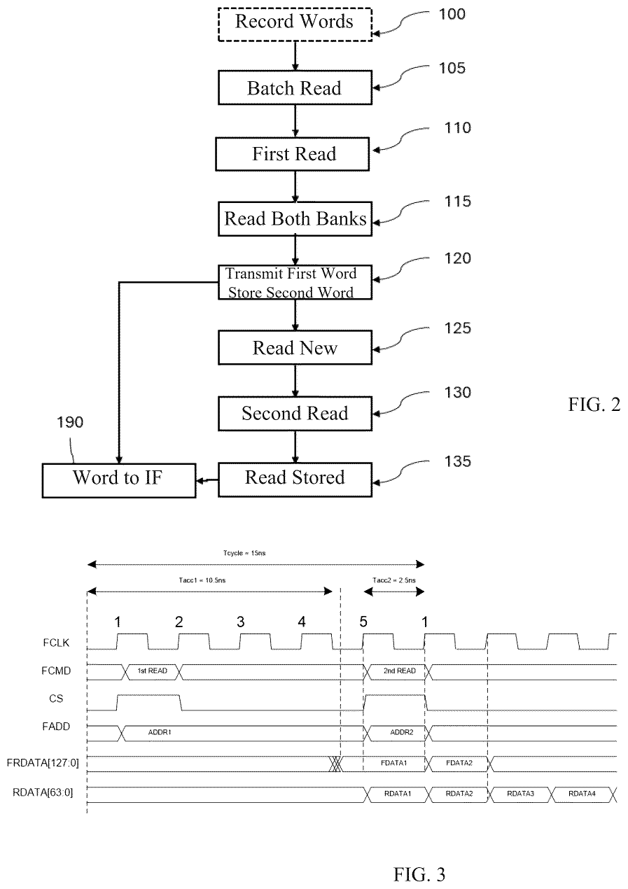

FIG. 2 illustrates, using a flow chart, steps of a memory device reading process, such as the NVM device 1 when operating in the 2N mode. Operations in the N mode remain conventional and do not need to be described in more detail here.

In the optional step 100, the data words 20, 21 are recorded at the same bank address 25 in the two memory banks 3, 4 by the NVM controller 5 following receipt of data commands WRITE 1, WRITE 2 from the memory interface 2. In one example, the data words 20, 21 are already preferably recorded at the same bank address 25 before the steps of the method described here.

In step 105, the memory interface 2 receives one or more instructions from the host device 30 for reading a data word 20 in a memory bank 3, 4. For example, it receives a batch read instruction (WRAP burst) of four 64-bit words.

In step 110, the memory interface 2 converts the read instruction(s) into a first data read command READ 1, and transmits said command to the NVM controller 5. The read command READ 1 sent by the memory interface 2 comprises a physical address for reading a 128-bit data word, for example.

The memory interface 2 can determine whether the control is a type 1 or a type 2 control. Here, the command READ 1 is of type 1.

Alternatively, or in combination, the command READ 1 contains a read address having a MSB bit indicating the target bank memory and LSB bits defining a bank memory address.

In step 115, the NVM controller 5, in response to the first command READ 1, simultaneously reads the first data word 20 at the bank memory address 25 in the first of the non-volatile memory banks 3 which corresponds to the first read memory address 22 and the second data word 21 at the same bank memory address 25 in the second non-volatile memory bank 4. Simultaneous reading is performed by simultaneously indicating the same bank memory address 25 on the two address buses 12, and by simultaneously reading the data buses 11 of the two banks 3, 4.

In step 120, the NVM controller 5 transmits the first data word 20 read to the memory interface 2 and stores the second data word 21 read in the data register 8 of the NVM controller 5.

This first data word 20 can then be transmitted by the memory interface 2 via the bus 10, in the form of two words of 64 bits for example, to the host device 30 in step 190.

In parallel, in step 125, the memory interface 2 receives an instruction from the host device 30 to read a new data word 21 in a memory bank 3, 4. It should be noted that this instruction may be common to the instruction of step 105, typically during a batch read instruction.

In step 130, the memory interface 2 converts this read instruction into a second read data command READ 2, and transmits said command to the NVM controller 5.

The memory interface 2 can determine whether the control is a type 1 or a type 2 control. Here, the command READ 2 is of type 2 since it seeks to read a data word 21 stored at the same bank memory address as the previously read data word 20, but in the other NVM memory bank.

As a variant or in combination, the command READ 2 contains a read address having an MSB bit different from that indicated in the command READ 1, but LSB bits identical to those indicated in the command READ 2.

In step 135, the NVM controller 5, in response to the first command READ 2, reads the second data word 21 directly from the data register 8, without accessing the memory banks. It then transmits the second data word 21 read to the memory interface 2. Optionally, the NVM controller 5 waits for a clock cycle before sending the second data word 21 read from the data register 8 to the memory interface 2.

This second data word 20 can then be transmitted by the memory interface 2 via the bus 10, in the form of two words of 64 bits for example, to the host device 30 in step 190.

FIG. 3 shows a timing diagram illustrating an example of read operation signals in the 2N-bit mode (here N=128 bits), at the memory interface 2.

The signal FCLK represents the clock cycles, for example with a period of 2.5 ns. The signal CS represents the control signal to control the activation of the NVM controller 5. The signal/bus FCMD represents the control signal, which can simply distinguish between read or write commands, or distinguish between type 0, 1 or 2 read and write commands. The signal/bus FADD represents the read/write address communicated to the NVM controller 5. The signal/bus FRDATA (here on N=128 bits) represents the data exchanged between the memory interface 2 and the NVM controller 5 (i.e., the internal bus 13). The signal/bus RDATA (here on N/2=64 bits) represents the data exchanged between the memory interface 2 and the host device 30 (i.e., the external bus 10).

During the first clock cycle, the first read command READ 1 (signal FCMD) is sent to the NVM controller 5 with address ADDR1 (signal FADD). The memory controller 5 must here perform the simultaneous reading of the two NVM memory banks 3, 4. In addition, four clock cycles elapse before the NVM controller 5 returns the requested and read data word 20 to the fifth clock cycle (FDATA1 in the signal FRDATA).

In the same fifth clock cycle, the memory interface 2 can send the second read command READ 2 (signal FCMD) to the fifth clock cycle. The NVM controller 5 must here only read the requested data word 21 in the register 8. Also, at the next clock cycle, the NVM controller 5 is able to return (FDATA2 in the signal FRDATA) this second read data word 21.

In a variant offering more time to the NVM controller 5 to read the register 8, the NVM controller 5 sends the second data word 21 from the register 8 to the memory interface 2, after a waiting clock cycle following the reception of the second read command READ 2.

The signal RDATA shows that the read data 20, 21 can be placed on the system bus 10 (of 64 bits) to the microcontroller 31, in the form of 64-bit words without a wait clock cycle (or “wait state”).

Indeed, the memory interface 2 can place, on the system bus 10, the first 64-bit word (RDATA1) from the first data word 20 (FDATA1) in the same clock cycle as its reception on the bus 13. It can then place the second 64-bit word (RDATA2) from the first data word 20 read in the next clock cycle, corresponding to the reception of the second data word 21 (FDATA2) on the bus 13 (in FIG. 1). Having the second data word 21, the memory interface 2 can chain the transmission of two 64-bit words (RDATA3, RDATA4) on the bus 10.

It should be noted that in the variant where the NVM controller 5 waits for a waiting clock cycle before transmitting the second data word 21 (FDATA2) on the bus 13, this waiting cycle has no impact on the transmission rate of the 64-bit words (RDATA) on the bus 10, insofar as this second data word 21 (FDATA2) would be received in the cycle where the third 64-bit word (RDATA3) can be transmitted.

This makes it possible to sequence reads on the NVM device 1 by limiting standby clock cycles.

A total of 256 bits are read from the NVM device 1 in eight clock cycles.

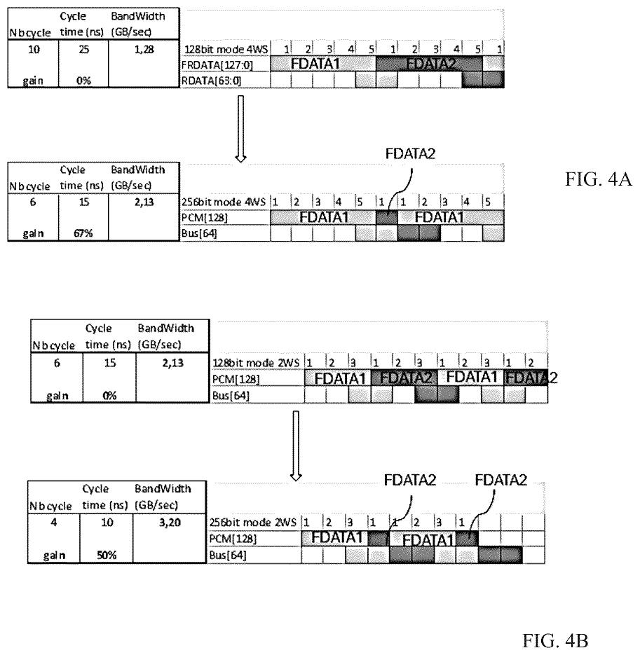

FIG. 4A and FIG. 4B illustrate performance of the method described above, in two scenarios, for responding to a batch read instruction (Wrap burst) of four words of 64 bits to obtain 256 bits (N=128 bits).

The first scenario shown in FIG. 4A corresponds to the case of an NVM device 1 having an intrinsic latency of four clock cycles (four wait states) during reads from the NVM memory banks 3, 4, while the second scenario shown in FIG. 4B corresponds to the case of an NVM device 1 having an intrinsic latency of two clock cycles (two wait states) during reads from the NVM memory banks 3, 4.

The tables and chronologies in the upper part of FIG. 4A and FIG. 4B show the efficiency of the NVM device 1 in the 128-bit mode (N-bit mode), while the tables and chronologies in the lower part of FIG. 4A and FIG. 4B show the efficiency of the NVM device 1 in the 256-bit mode (2N-bit mode). On the chronologies, the clock cycles devoted to obtaining the first data word 20 are referenced FDATA1, while the clock cycles devoted to obtaining the second data word 21 are referenced FDATA2.

In the first scenario illustrated in FIG. 4A, the number of clock cycles required to obtain the two 128-bit words 20, 21 in the N-bit mode is 10, or 25 ns. Indeed, each access to the NVM memory bank requires one clock cycle plus four latency cycles. The theoretical throughput of the NVM device 1 is then 1.28 GB/s (gigabytes per second).

In comparison, the number of clock cycles required to obtain the two 128-bit words 20, 21 in the 2N-bit mode is only 6, i.e., 15 ns, because the second data word 21 is obtained by reading directly in the register 8 without suffering from the latency of access to the NVM memory banks. The theoretical throughput of the NVM device 1 is then 2.13 GB/s. A theoretical gain of 67% is therefore observed. This gain is maintained on condition that the desired 256-bit data are grouped in locations having the same bank addresses, within the two NVM memory banks 3, 4.

In the second scenario illustrated in FIG. 4B, the number of clock cycles required to obtain the two 128-bit words 20, 21 in the N-bit mode is 6, or 15 ns. Indeed, each access to the NVM memory bank requires one clock cycle plus two latency cycles. The theoretical throughput of the NVM device 1 is then 2.13 GB/s.

In comparison, the number of clock cycles required to obtain the two 128-bit words 20, 21 in the 2N-bit mode is only 4, i.e., 10 ns, because the second data word 21 is obtained by reading directly in the register 8 without suffering from the latency of access to the NVM memory banks. The theoretical throughput of the NVM device 1 is then 3.20 GB/s. A theoretical gain of 50% is therefore observed.

Of course, the present disclosure is not limited to the embodiments described above by way of example; it extends to other variants. Other embodiments are possible.

The following reference numbers are used in the description and accompanying drawings: 1—NVM device; 2—memory interface; 3, 4—memory bank; 5—NVM controller; 8 data register; 10—system bus; 11—data bus; 12—address bus; 13—internal bus; 20—first data unit; 21—second data unit; 22—first memory address; 23—second memory address; 24—mode bit; 25—bank address; 30—host device; 31—microcontroller; 32—user memory; 33—memory management unit; 34—memory controller; 35—cache memory; 36—input/output interface 36; M1—first mode bit value; M2—second mode bit valuel READ 1—first read command; READ 2—second read command.

1. A memory device, comprising:
at least two non-volatile memory (NVM) banks configured to store data;
a memory interface configured to receive instructions from a host device; and
a NVM controller connected to the at least two NVM banks, wherein the NVM controller is configured to receive, from the memory interface, a first command for reading a data unit, the first command indicating a first read memory address, and in response to the first command:
simultaneously read a first data unit at a bank memory address in a first bank of the NVM banks corresponding to the first read memory address and a second data unit at the same bank memory address in a second bank of NVM memory banks; and
transmit the read first data unit to the memory interface and store the read second data unit in a data register of the NVM controller.

2. The memory device according to claim 1, wherein the NVM controller is further configured to receive, from the memory interface, a second command to read a data unit and in response to the second command: read the second data unit from the data register and transmit the read second data unit to the memory interface.

3. The memory device according to claim 2, wherein the memory controller is further configured to send the second data unit read from the data register to the memory interface after a wait clock cycle following receipt of the second read command.

4. The memory device according to claim 1, wherein the memory interface is configured to determine whether a new command to be sent to the NVM controller is of a first type or of a second type, wherein the new command to be sent is the second type if a data unit to be read in response to the new command is stored at the same bank memory address as the first data unit read by the first command but in the second memory bank, and if not then the new command to be sent is the first type.

5. The memory device according to claim 4, wherein the NVM controller is configured, where the new command received is the first type, to read the second data unit in the second memory bank, and wherein the NVM controller is configured, where the new command is the second type, to read the second data unit in the data register.

6. The memory device according to claim 5, wherein, the NVM controller is configured to send the second data unit read from the data register to the memory interface in the clock cycle following receipt of the second read command.

7. The memory device according to claim 1, wherein the first read memory address comprises one or more bank control bits and separate bits defining the bank memory address.

8. The memory device according to claim 1, wherein the data unit comprises a data word and an error correcting code, wherein the data word is a binary word of 16, 32, 64, 128, 256, 512 or 1024 bits.

9. The memory device according to claim 1, comprising a mode bit configurable to take either a first value or a second value, the memory device being configured to:
when the mode bit takes the first value, control the NVM controller so that in response to a read command, the NVM controller reads only one of the non-volatile memory banks and transmits to the memory interface a read data unit; and
when the mode bit takes the second value, control the memory controller so that in response to a read command, either the NVM controller simultaneously reads the first and second non-volatile memory banks, at the bank memory address, transmits a read data word to the memory interface and stores the other read data word in the data register, or the NVM controller reads only one data word directly in the data register.

10. The memory device according to claim 1, wherein the memory interface is configured to receive a data write instruction, convert said write command into two data write commands and transmit said commands to the NVM controller to write the data into two data units stored at the same bank address in the two memory banks.

11. A method for reading data units in a memory device comprising the steps of:
receiving by a memory interface read commands from a host device;
transmitting by the memory interface to a non-volatile memory (NVM) controller a first read command of a data unit, the first read command indicating a first read memory address; and
in response to the first read command:
simultaneously reading by the NVM controller a first data unit at a memory address of a first bank of a non-volatile memory corresponding to the first read memory address and reading a second data unit at the same memory address of a second bank of the non-volatile memory; and
transmitting by the NVM controller the read first data unit to the memory interface and storing the second data unit in a data register of the NVM controller.

12. The method according to claim 11, further comprising:
receiving, by the NVM controller from the memory interface, a second command to read a data unit; and
in response to the second command: reading the second data unit from the data register and transmitting the read second data unit to the memory interface.

13. The method according to claim 11, further comprising:
determining, by the memory interface, whether a new command to be sent to the NVM controller is of a first type or of a second type;
where the new command to be sent is the second type if a data unit to be read in response to the new command is stored at the same bank memory address as the first data unit read by the first command but in the second memory bank, and if not then the new command to be sent is the first type.

14. The method according to claim 13, further comprising:
where the new command received is the first type, reading by the NVM controller read the second data unit in the second memory bank; and
where the new command is the second type, reading by the NVM controller the second data unit in the data register.

15. The method according to claim 14, further comprising:
sending, by the NVM controller, the second data unit read from the data register to the memory interface in the clock cycle following receipt of the second read command.

16. A memory device clocked by clock cycles, comprising:
a memory interface configured to receive instructions to read four N/2-bit words from a host device and to send data read from memory on a system bus of N/2 bits to the host device;
an memory controller connected to at least two non-volatile memory banks storing data on N bits;
wherein the memory controller is configured to receive, from the memory interface, a first command to read a data unit of N bits followed by a second command to read a data unit of N bits, the first command indicating a first read memory address and the second command indicating a second read memory address; and
wherein the memory controller is further configured, in response to the first command, to:
simultaneously read a first data unit of N bits to a store memory address in a first of the non-volatile memory stores that corresponds to the first read memory address and a second data unit of N bits to the same store memory address in the second non-volatile memory bank that corresponds to the second read memory address;
transmit the first data unit read to the memory interface; and
store the second data unit in a data register of the memory controller; and
wherein the memory controller is further configured, in response to the second command received at a same clock cycle as the transmission of the first data unit, to:
read the second data unit from the data register; and
transmit, at a next clock cycle, the second unit of data is read from the memory interface;
wherein the memory interface is configured to transmit two words to the host device on the system bus of N/2 bits corresponding to the first unit of data read followed by two words of N/2 bits corresponding to the second unit of data read, over four consecutive clock cycles.

17. A method for reading the units of data from a memory device clocked by clock cycles, the method comprising steps of:
receiving, from a host device, through a memory interface four-word reading instructions of N/2 bits;
transmitting through the memory interface to a memory controller a first command to read an N bit data unit followed by a second command to read an N bit data unit, the first read command indicating a first read memory address and the second command indicating a second read memory address;
in response to the first command:
simultaneously reading by the memory controller a first data unit of N bits to a memory address of a first bank of non-volatile memory corresponding to the first read memory address and reading a second data unit of N bits to the same memory address of a second bank of non-volatile memory which corresponds to the second read memory address; and
transmitting the first data unit read from the memory controller to the memory interface; and
storing the second data unit in a data register of the memory controller; and
in response to the second command received at a same clock cycle as the transmission of the first data unit:
reading the second data unit from the data register; and
transmitting, at the next clock cycle, the second data unit read from the memory interface; and
transmitting, through the memory interface to the host device on the system bus, two N/2-bit words corresponding to the first data unit read followed by two N/2-bit words corresponding to the second data unit read, over four consecutive clock cycles.
